(19) United States
(12) Patent Application Publication
(10) Pub. No.: US 2025/0252948 A1
(43) Pub. Date: Aug. 7, 2025

(54) EXPRESSING EMOTION IN SPEECH FOR CONVERSATIONAL AI SYSTEMS AND APPLICATIONS

(71) Applicant: NVIDIA Corporation, Santa Clara, CA (US)

(72) Inventors: Ehsan Hosseini Asl, San Jose, CA (US); Oluwatobi Olabiyi, Falls Church, VA (US); Seth Schneider, San Jose, CA (US); Pritam Biswas, San Jose, CA (US); Akshay Hazare, Mumbai (IN)

(21) Appl. No.: 18/668,529

(22) Filed: May 20, 2024

Related U.S. Application Data
(60) Provisional application No. 63/550,256, filed on Feb. 6, 2024.

(51) Int. Cl. G10L 13/027

(52) U.S. Cl. CPC G10L 13/027

(57) ABSTRACT

In various examples, expressing emotion in speech for conversational AI systems and applications is described herein. Systems and methods are disclosed that use one or more machine learning models (e.g., one or more language models) to determine one or more attributes associated with speech, such as one or more emotion attributes and/or one or more response attributes, and then use the attribute(s) to generate the speech that expresses emotion. In some examples, the machine learning model(s) may use various types of information to determine the attribute(s), such as user information, character information, a dialogue history, a current prompt, and/or so forth. For instance, using the information, the machine learning model(s) may determine one or more tags associated with emotional states and/or voice characteristics, where the tag(s) is then used to generate the speech in a voice that relates to the emotion.

### CROSS-REFERENCE TO RELATED APPLICATIONS

This application claims the benefit of U.S. Provisional Application No. 63/550,256, filed on Feb. 26, 2024, the contents of which are hereby incorporated by reference in their entirety.

### BACKGROUND

Many applications, such as gaming applications, interactive applications, communications applications, multimedia applications, videoconferencing applications, in-vehicle infotainment applications, and/or the like, use animated characters or digital avatars that interact with users of the applications/machines/devices and/or interact with other animated characters within the applications (e.g., non-player characters (NPCs)). In order to provide more realistic experiences for users, systems may attempt to animate characters by expressing emotion when interacting with users. For example, when determining speech that an animated character is to output to a user, a system may also determine an emotional state associated with the animated character, such as based on an analysis of the text of the speech. The emotional state may then be used such that the animated character outputs the speech in a way that expresses the emotional state. For example, the voice of the animated character that is used to output the speech may reflect the emotional state of the animated character.

However, by only using the text of the speech to determine emotional states, the systems may incorrectly determine the emotional states based on the circumstances of the interactions. For example, people may express the same text, such as “Have a good day,” using different emotional states, such as happy or indifferent. As such, by merely associating text with an emotional state that is then later used by animated characters when outputting speech corresponding to the text, the animated characters may express their speech using an improper or inaccurate emotional state that may result in an undesired or unnatural user experience. Additionally, by only using set emotional states for animated characters, such as happy or sad, the systems may be unable to cause the animated characters to express a wide range or spectrum of emotional states with speech. For example, people may express the same emotional state differently at different times, such as if a person is somewhat happy or very happy. When expressing the same emotional state differently, the user's speech may also change, such as the characteristics (e.g., pitch, rate, etc.) of the user's speech.

### SUMMARY

Embodiments of the present disclosure relate to expressing emotion in speech for conversational AI systems and applications. Systems and methods are disclosed that use one or more machine learning models (e.g., one or more language models—such as a large language model (LLM) and/or a vision language model (VLM)) to determine one or more attributes associated with speech, such as one or more emotion attributes and/or one or more response attributes, and then use the attribute(s) to generate the speech that expresses emotion. In some examples, the machine learning model(s) may use various types of information to determine the attribute(s), such as user information, character information, a dialogue history, input text (e.g., a prompt), visual information, audio information, and/or so forth. For instance, using the information, the machine learning model(s) may determine one or more tags associated with emotional states and/or voice characteristics, where the tag(s) is then used to generate the speech in a voice that relates to the emotion.

In contrast to conventional systems, the systems of the present disclosure are able to determine emotion associated with speech using additional inputs in concert with the text of the speech, such as user information, character information, visual information, audio information, and/or a dialogue history. As described in more detail herein, by using the additional inputs, the current systems may then better determine the actual emotion of the speech—e.g., because the same text may be associated with different emotion based on other circumstances associated with the speech. Additionally, in contrast to the conventional systems, the current systems, in some embodiments, are able to determine additional values for variables, attributes, and/or tags associated with the emotion and/or the speech. As described in more detail herein, by determining the additional values for the variables, attributes, and/or tags, the current systems are again able to better determine the actual emotion of the speech-e.g., because the variables may change the emotion and/or voice characteristics associated with the speech.

### BRIEF DESCRIPTION OF THE DRAWINGS

The present systems and methods for expressing emotion in speech for conversational AI systems and applications are described in detail below with reference to the attached drawing figures, wherein:

FIG. 1 illustrates an example data flow diagram of a process of using one or more machine learning models to generate speech that expresses emotion, in accordance with some embodiments of the present disclosure;

FIG. 2 illustrates an example of one or more language models determining attributes associated with input text, in accordance with some embodiments of the present disclosure;

FIG. 3 illustrates an example of one or more language models determining emotion and output text associated with input text, in accordance with some embodiments of the present disclosure;

FIG. 4 illustrates an example of generating speech that expresses emotion, in accordance with some embodiments of the present disclosure;

FIG. 5A illustrates a data flow diagram illustrating a process for training one or more language models to generate speech that expresses emotion during a first training stage, in accordance with some embodiments of the present disclosure;

FIG. 5B illustrates a data flow diagram illustrating a process for training one or more language models to generate speech that expresses emotion during a second training stage, in accordance with some embodiments of the present disclosure;

FIG. 6A illustrates an example of generating response attributes for training one or more language models, in accordance with some embodiments of the present disclosure;

FIG. 6B illustrates an example of generating emotion attributes for training one or more language models, in accordance with some embodiments of the present disclosure;

FIG. 6C illustrates an example of generating ground truth data for training one or more language models, in accordance with some embodiments of the present disclosure;

FIG. 7 illustrates a flow diagram showing a method for using models to generate speech that expresses emotion, in accordance with some embodiments of the present disclosure;

FIG. 8 illustrates a flow diagram showing a method for using one or more models that control emotions to generate speech, in accordance with some embodiments of the present disclosure;

FIG. 9 illustrates a flow diagram showing a method for using one or more models that manage emotion dialogue to generate speech, in accordance with some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Systems and methods are disclosed related to expressing emotion in speech for conversational AI systems and applications. For instance, a system(s) may receive input data associated with at least one of a user or a character that is being animated. For example, and for the user, the input data may include first text data representing text (e.g., a prompt) input by the user (or converted from audio), second text data representing emotional information (e.g., one or more emotional states) associated with the user, audio data representing speech from the user (e.g., in the form of a spectrogram), image or video data representing one or more images or videos depicting the user, profile data representing information about the user, and/or any other type of data. As described herein, text may represent one or more letters, words, symbols, numbers, characters, punctuation marks, tokens, and/or the like. Additionally, and for the character, the input data may represent character information such as characteristics associated with the character (e.g., profession, relationships, personality traits, etc.), past communications, current circumstances (e.g., current interactions with other characters, current location, current objectives, etc.), and/or any other information associated with the character. While these examples describe the input data as being associated with the user and/or the character, in other examples, the input data may include any other type of input data.

In some examples, the system(s) may then be configured to process at least a portion of the input data (e.g., the input data associated with the user, the character information, etc.) and/or data (referred to, in some examples, as “history data”) representing a dialogue history between the user and the character using one or more first machine learning models (referred to, in some examples, as the “first model(s)” and/or the “state model(s)”), such as one or more language models. As described herein, the first model(s) may be configured to manage an emotional dialogue flow associated with a conversation by predicting the emotion associated with the speech. For instance, based at least on processing the at least the portion of the input data and/or the history data, the first model(s) may generate and/or output a first output representing one or more attributes associated with emotion (also referred to as the “emotion attribute(s)) and/or one or more attributes associated with a response (also referred to as the “response generic attribute(s)”).

In some examples, the emotion attribute(s) may be associated with one or more labels associated with one or more emotional states, one or more values (e.g., intensity values) associated with the label(s), and/or the like. As described herein, an emotional state may include, but is not limited to, monotone, indifferent, anger, disgust, fearful, happy, sad, anticipation, trust, surprise, and/or any other emotional state. Additionally, the emotion attribute(s) may be associated with the user (e.g., also referred to as a “user emotion attribute(s)”) that provided the input and/or a response (e.g., also referred to as a “response emotion attribute(s)”) to the input. For instance, the user emotion attribute(s) may be associated with the emotion of the user, where the user emotion attribute(s) may include one or more values associated with one or more emotional state labels. Additionally, the response emotion attribute(s) may be associated with the emotion of the character's response, where the response emotion attribute(s) may include one or more values associated with one or more emotional state labels.

Additionally, in some examples, the response generic attribute(s) may be associated with one or more labels associated with a character and/or the response, one or more values (e.g., intensity values) associated with the label(s), and/or the like. As described herein, the label(s) associated with the character and/or the response may include, but is not limited to, quality, toxicity, creativity, helpfulness, humor, correctness, coherence, verbosity, and/or any other label. For instance, the label(s) associated with the character and/or the response may be associated with various attributes of the character that are input, such as based on a bio and/or personality of the character, and/or updated during the conversation.

In some examples, the system(s) may then be configured to process at least a portion of the input data (e.g., the first text data, the character information, etc.) and/or at least a portion of the first output from the first model(s) using one or more second machine learning models (referred to, in some examples, as the “second model(s)” and/or the “steer model(s)”), such as one or more language models. As described herein, the second model(s) may be configured to control the emotions associated with responses, such as by controlling the emotions of the character outputting the responses. For instance, based at least on processing the at least the portion of the input data and/or the at least the portion of the first output, the second model(s) may generate and/or output a second output representing (1) output text (e.g., speech synthesis markup language, etc.) and/or (2) one or more voice tags associated with emotion (e.g., one or more emotional states) and/or one or more characteristics of speech. For instance, if the input text includes a prompt, then the output text may represent a response to the prompt. Additionally, as described herein, a characteristic associated with speech may include, but is not limited to, a pitch, a volume, a tone, a rhythm, a timbre, an intensity, a resonance, a tempo, and/or any other characteristic.

In some examples, the system(s) may then be configured to process at least a portion of the second output using one or more third machine learning models (referred to, in some examples, as the “third model(s)”), such as one or more text-to-speech (TTS) models. For instance, based at least on processing the at least the portion of the second output, the third model(s) may generate and/or output audio data representing speech corresponding to the output text. For example, if the output text includes a response to the prompt, then the speech may include one or more words corresponding to the response. Additionally, as described herein, the third model(s) may generate the speech in a way that expresses emotion corresponding to the voice tag(s) from the second output. For example, if the second output indicates that the emotion is calm with a medium volume, then the speech may be expressed using a calm voice with a medium volume.

In some examples, the system(s) may then continue to perform these processes as the system(s) continues to receive additional inputs (e.g., additional prompts) from the user. For instance, as the user continues to have the conversation with the character, the system(s) may continue to perform these processes to generate speech corresponding to responses to the input prompts from the user. As described herein, by performing these processes, one or more portions of a response and/or one or more of the responses (e.g., each response) may be associated with a respective emotion, such that the emotion of the speech and/or the character changes during the conversation. This way, the system(s) may better animate the character during the conversation as compared to the conventional systems described above.

Although described as using two or more models in a pipeline, in some embodiments, a single model may be used to perform each of these tasks, such as, without limitations, an LLM or a VLM.

In some examples, the system(s) may train one or more of the models described herein using one or more techniques. For instance, the system(s) may train, during a first training stage, the second model(s) to generate outputs representing (1) instances of output text (e.g., responses) associated with instances of input text (e.g., prompts) and/or (2) voice tags associated with emotion and/or voice characteristics corresponding to the instances of output text. For instance, during the first training stage, the second model(s) may be trained using training input data representing the instances of input text, attributes (e.g., response attributes, emotion attributes, etc.), and/or character information, as well as corresponding ground truth data representing the instance of output text and the voice tags.

Before, during, and/or after the first training stage, the system(s) may train the first model(s) and/or further train the second model(s) during a second training stage. For a first example, the system(s) may train the first model(s) to generate outputs representing the attributes (e.g., the response attributes, the emotion attributes, etc.). In such an example, the first model(s) may be trained using training input data representing user information (e.g., text, images, audio, etc.), instances of input text, character information, and/or a dialogue history, as well as corresponding to ground truth data representing the attributes. For a second example, the system(s) may train the first model(s) to generate the outputs representing the attributes while also training the second model(s) to generate the outputs representing (1) the instances of output text (e.g., responses) associated with the instances of input text (e.g., prompts) and/or (2) the voice tags corresponding to the instances of output text. In this second example, the system(s) may train the first model(s) and/or the second model(s) using training input data representing the user information (e.g., text, images, audio, etc.), the instances of input text, the character information, and/or the dialogue history, as well as corresponding ground truth data representing the instances of output text and the voice tags.

As will be described in more detail herein, the system(s) may use one or more techniques to generate the training data, such as the training input data and/or the ground truth data. For instance, in some examples, the system(s) may generate at least a portion of the training data using inputs from users, where the inputs indicate the information (e.g., the instances of input text, the attributes, the character information, the instances of output text, the voice tags, etc.) represented by the training data. Additionally, or alternatively, in some examples, the system(s) may generate at least a portion of the training data using one or more additional machine learning models. For example, and for an instance of training data that is associated with an instance of input text, the system(s) may use the additional model(s) to generate at least the emotion attribute(s), the response attribute(s), the instance of output text, and/or the voice tag(s) associated with the instance of input text. Additionally, the system(s) may perform similar processes to generate any number of instances of training data for training the first model(s) and/or the second model(s).

While the examples herein describe using the first model(s) to generate the first output, the second model(s) to generate the second output, and the third model(s) to generate the audio data, in other examples, one or more of the first model(s), the second model(s), or the third model(s) may be combined. For a first example, the first model(s) and the second model(s) may be combined such that the combined model(s) receives the inputs described herein with respect to the first model(s) and then outputs the second outputs described herein with respect to the second model(s). For a second example, the first model(s), the second model(s), and the third model(s) may be combined such that the combined model(s) receives the inputs described herein with respect to the first model(s) and then outputs the audio data as described herein with respect to the third model(s). Still, for a third example, the second model(s) and the third model(s) may be combined such that the combined model(s) receives the inputs described herein with respect to the second model(s) and then outputs the audio data described herein with respect to the third model(s).

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

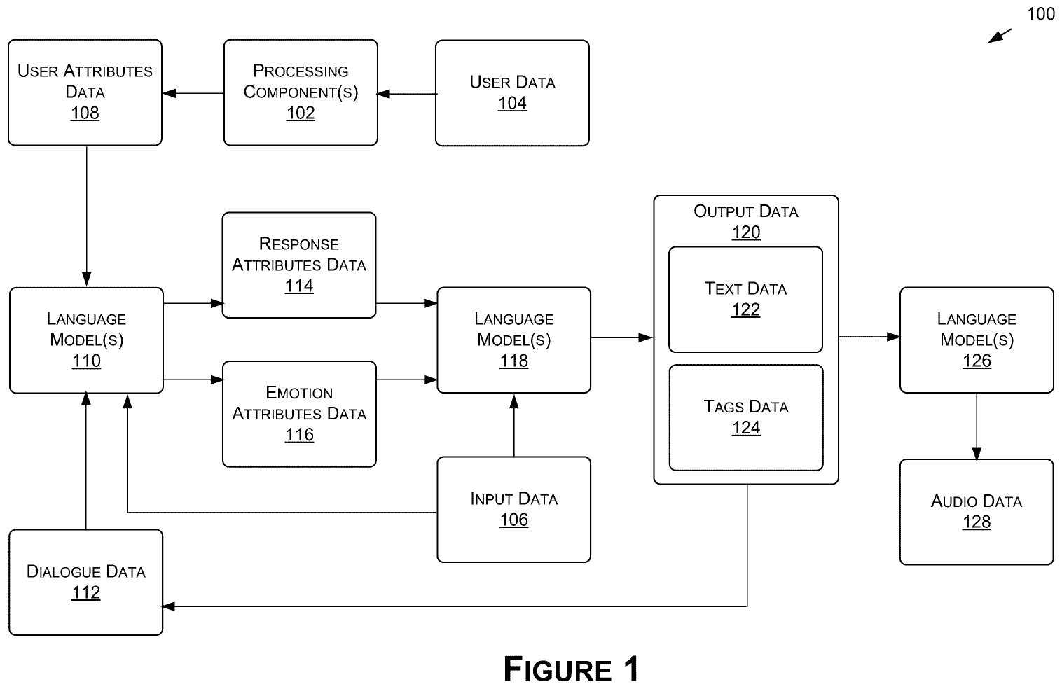

With reference to FIG. 1, FIG. 1 illustrates an example data flow diagram of a process 100 of using one or more machine learning models to generate speech that expresses emotion, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more processing components 102 receiving user data 104 associated with a user. As described herein, the processing component(s) 102 may include, but is not limited to, one or more machine learning models (e.g., one or more audio to emotion models, one or more audio to gesture models, etc.), one or more neural networks, one or more algorithms, one or more modules, and/or any other type of processing component that is configured to perform the processes described herein with respect to the processing component(s) 102. Additionally, the user data 104 may include, but is not limited to, first text data (e.g., at portion of input data 106) representing input text (e.g., a prompt, such as a question, a request, an instruction, a demand, a note, and/or any other type of speech) by the user (or converted from audio), audio data representing speech from the user (e.g., in the form of a spectrogram), image data or video data representing one or more images or videos depicting the user, profile data representing information about the user (such as when the user provides consent for receiving and/or storing such information), and/or any other type of data. In some examples, at least a portion of the user data 104 may be generated using one or more client devices (e.g., one or more computing devices 1000).

The process 100 may then include the processing component(s) 102 processing at least a portion of the user data 104 and, based at least on the processing, generating user attributes data 108 associated with the user. In some examples, the user attributes data 108 may represent one or more labels (e.g., one or more tags) associated with one or more emotional states corresponding to the user. As described herein, an emotional state may include, but is not limited to, monotone, indifferent, anger, disgust, fearful, happy, sad, anticipation, trust, surprise, and/or any other emotional state. Additionally, in some examples, the user attributes data 108 may represent one or more values (e.g., one or more intensity scales) associated with the label(s). As described herein, a value associated with a label may be within a range, such as a range between 0 and 5 (and/or any other range). For example, the user attributes data 108 may represent a first value associated with a first emotional tag, a second value associated with a second emotional tag, a third value associated with a third emotional tag, and/or so forth.

As described herein, the processing component(s) 102 may perform various types of processing to generate the user attributes data 108. For a first example, such as when the user data 104 includes audio data representing speech from the user, the processing component(s) 102 may process the audio data using one or more audio processing techniques to determine the information represented by the user attributes data 108. For a second example, such as when the user data 104 includes image data representing the image(s) depicting the user, the processing component(s) 102 may process the image data using one or more image processing techniques in order to determine the information represented by the user attributes data 108. While the example of FIG. 1 illustrates the processing component(s) 102 being separate from one or more language models 110, in other examples, the processing component(s) 102 may be included as part of (e.g., one or more layers of) the language model(s) 110.

The process 100 may then include the language model(s) 110 receiving data as input, such as at least a portion of the user attributes data 108, at least a portion of the input data 106, and/or at least a portion of dialogue data 112. In some examples, the input data 106 for the language model(s) 110 may represent an instance of input text from the user, character information associated with a character that is configured to output speech, and/or any other type of information. Additionally, the character information may include, but is not limited to, characteristics associated with the character (e.g., profession, relationships, personality traits, etc.), past communications, current circumstances (e.g., current interactions with other characters, current location, current objectives, etc.), and/or any other information associated with the character and/or the application (e.g., the game) associated with the character. Furthermore, the dialogue data 112 may represent one or more past communications between the user and the character, such as one or more previous instances of input text (e.g., one or more previous prompts) and/or one or more previous instances of output text (e.g., one or more previous responses) associated with the previous instance(s) of input text.

The process 100 may then include the language model(s) 110 processing the inputted data and, based at least on the processing, generating and/or outputting response attributes data 114 associated with one or more response generic attributes and/or emotion attributes data 116 associated with one or more emotion attributes. As described herein, in some examples, the emotion attribute(s) may be associated with one or more labels corresponding to one or more emotional states, one or more values (e.g., intensity values) associated with the label(s), and/or any other information. Additionally, the emotion attribute(s) may be associated with the user (e.g., also referred to as a “user emotion attribute(s)”) that provided the input and/or a response (e.g., also referred to as a “response emotion attribute(s)”) to the input. Furthermore, a value associated with a label may be within a range, such as a range between 0 and 5 (and/or any other range).

For a first example, emotion attributes data 116 may represent user emotion attributes that include at least a first value for a first emotional state, a second value for a second emotional state, a third value for a third emotional state, and/or so forth for the user. For a second example, emotion attributes data 116 may represent response emotion attributes that include at least a first value for a first emotional state, a second value for a second emotional state, a third value for a third emotional state, and/or so forth for the response. In some examples, only one label may be associated with a value greater than zero (e.g., for the response emotion attribute(s)). In some examples, more than one label may be associated with a respective value that is greater than zero.

Additionally, in some examples, the response generic attribute(s) may be associated with one or more labels associated with a character and/or the response, one or more values (e.g., intensity values) of the label(s), and/or the like. As described herein, the label(s) associated with the character and/or the response may include, but is not limited to, quality, toxicity, creativity, helpfulness, humor, correctness, coherence, verbosity, and/or any other label. For instance, the label(s) associated with the character and/or the response may be associated with various attributes of the character that are input and/or updated during the conversation. Additionally, a value associated with a label may be within a range, such as a range between 0 and 5 (and/or any other range). For example, the response attributes data 114 may represent at least a first value associated with a first label, a second value associated with a second label, a third value associated with a third label, and/or so forth.

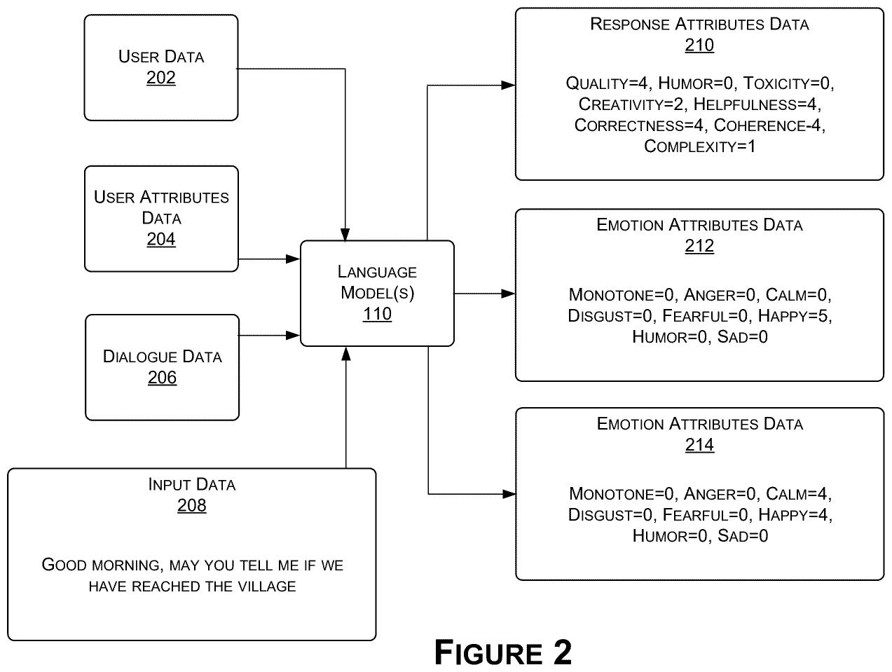

For instance, FIG. 2 illustrates an example of the language model(s) 110 determining attributes associated with input text, in accordance with some embodiments of the present disclosure. As shown, the language model(s) 110 may receive, as input, user data 202 (which may similar to, and/or include, at least a portion of the user data 104), user attributes data 204 (which may similar to, and/or include, at least a portion of the user attributes data 108), dialogue data 206 (which may similar to, and/or include, at least a portion of the dialogue data 112), and/or input data 208 (which may be similar to, and/or include, at least a portion of the input data 106). In the example of FIG. 2, the input data 208 represents input text, such as a prompt that includes “Good morning, may you tell me if we have reached the village.” The language model(s) 110 may then process the data and, based at least on the processing, generate and/or output response attributes data 210 (which may be similar to, and/or include, at least a portion of the response attributes data 114), emotion attributes data 212 (which may be similar to, and/or include, at least a portion of the emotion attributes data 116), and emotion attributes data 212 (which may be similar to, and/or include, at least a portion of the emotion attributes data 116).

As shown, the response attributes data 210 represents values for various response generic attributes, such as 4 associated with quality, 0 associated with humor, 0 associated with toxicity, 2 associated with creativity, 4 associated with helpfulness, 4 associated with correctness, 4 associated with coherence, and 1 associated with complexity. Additionally, the emotion attributes data 212 represents values associated with response emotion attributes, such as 0 associated with monotone, 0 associated with anger, 0 associated with calm, 0 associated with disgust, 0 associated with fearful, 5 associated with happy, 0 associated with humor, and 0 associated with sad. Furthermore, the emotion attributes data 214 represents values associated with user emotion attributes, such as 0 associated with monotone, 0 associated with anger, 4 associated with calm, 0 associated with disgust, 0 associated with fearful, 4 associated with happy, 0 associated with humor, and 0 associated with sad. While these are just a few response attributes and a few emotion attributes, in other examples, the response attributes data 210 may include one or more additional and/or alternative response attributes and/or the emotion attributes data 212 and 214 may include one or more additional and/or alternative emotion attributes.

Referring back to the example of FIG. 1, the process 100 may include one or more language models 118 receiving data as input, such as at least a portion of the input data 106, at least a portion of the response attributes data 114, and at least a portion of the emotion attributes data 116. The process 100 may then include the language model(s) 118 processing the data and, based at least on the processing, generating output data 120. As shown by the example of FIG. 1, the output data 120 may include at least text data 122 and tags data 124. In some examples, the text data 122 may represent an instance of output text (e.g., speech synthesis markup language, etc.) associated with the instance of input text, such as a response (e.g., information, instructions, a question, a request, etc.) to the prompt. Additionally, in some examples, the tags data 124 may represent one or more voice tags associated with at least one of an emotion (e.g., one or more emotional states) or one or more characteristics associated with speech. As described herein, a characteristic associated with speech may include, but is not limited to, a pitch, a volume, a tone, a rhythm, a resonance, a tempo, and/or any other characteristic.

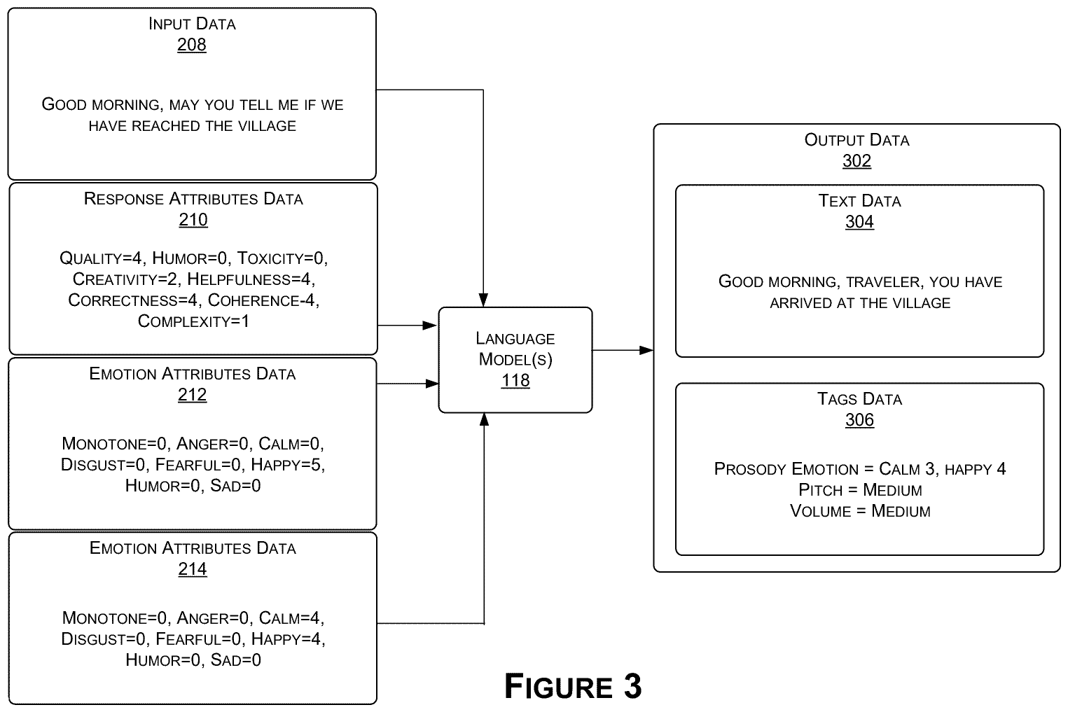

For instance, FIG. 3 illustrates an example of the language model(s) 118 determining emotion and output text associated with input text, in accordance with some embodiments of the present disclosure. As shown, the language model(s) 118 may receive, as input, at least the input data 208, the response attributes data 210, the emotion attributes data 212, and the emotion attributes data 214. The language model(s) 118 may then process the data and, based at least on the processing, generate output data 302 (which may be similar to, and/or include, at least a portion of the output data 120) that includes text data 304 (which may be similar to, and/or include, at least a portion of the text data 122) and tags data 306 (which may be similar to, and/or include, at least a portion of the tags data 124).

In the example of FIG. 3, the text data 122 may represent a response to the prompt associated with the input data 208. For instance, the text data 122 may represent text that includes “Good morning, traveler, you have arrived at the village.” Additionally, the tags data 306 may represent a prosody emotions tag that includes 3 associated calm and 4 associated with happy, a pitch tag that includes medium, and a volume tag that includes medium. While these are just a few examples of voice tags that may be represent by the tags data 306, in other examples, the tags data 306 may represent one or more additional and/or alternative voice tags.

Referring back to the example of FIG. 1, the process 100 may include one or more language models 126 receiving at least a portion of the output data 120 as input. The process 100 may then include the language model(s) 126 processing the data and, based at least on the processing, generating audio data 128 representing speech. As described herein, the speech represented by the audio data 128 may be associated with (e.g., include the words of) the text represented by the text data 122. Additionally, the speech may be expressed based at least on the emotion and/or the characteristic(s) associated with speech as represented by the tags data 124. For example, the audio data 128 may cause the speech to be spoken using one or more emotional states associated with the tag(s) represented by the tags data 124. Additionally, the audio data 128 may cause the speech to be spoken using the values of the characteristics associated with speech, such as the volume level, the pitch level, the rate speed, an emphasis if needed, and/or the like as represented by the tag(s) In other words, the language model(s) 126 may be configured to generate the audio data 128 such that the character outputs the speech in a way in which the emotion is expressed.

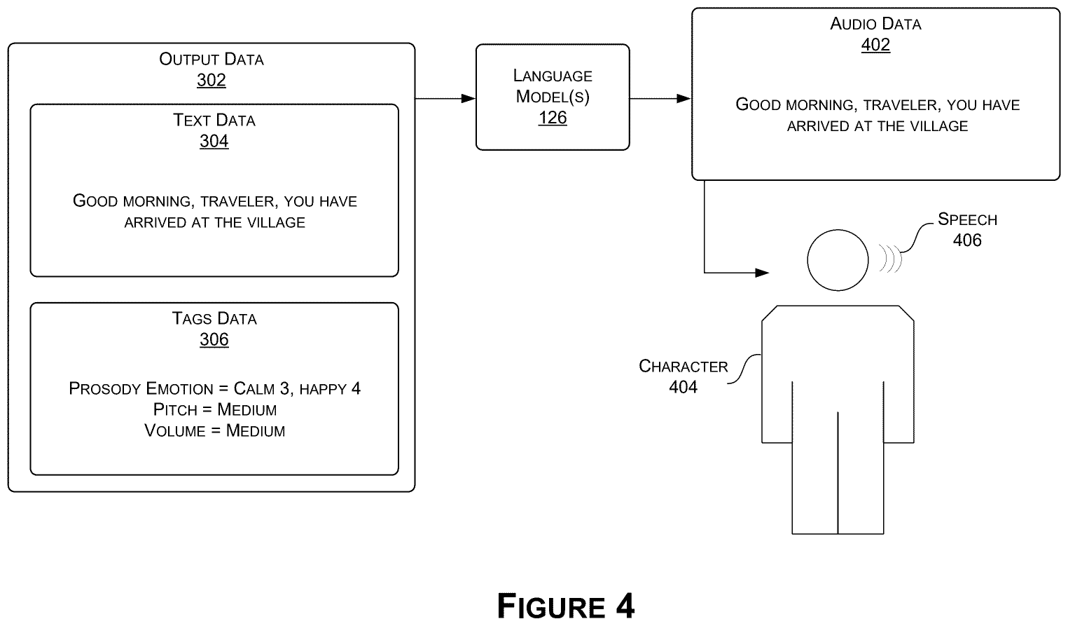

For instance, FIG. 4 illustrates an example of generating speech that expresses emotion, in accordance with some embodiments of the present disclosure. As shown, the language model(s) 126 may receive, as input, at least a portion of the output data 302. The language model(s) 126 may then process the at least the portion of the output data 302 and, based at least on the processing, generate audio data 402 (which may be similar to, and/or include, the audio data 128) representing speech. As shown, the speech includes the text “I am doing great, it is nice to see you today.” The audio data 402 may then be used to cause a character 404 to output the speech, which may be represented by 406. For instance, the character 404 may output the speech in a way that emphasizes the emotion and/or the characteristic(s) associated with speech as represented by the output data 302.

Referring back to the example of FIG. 1, while the example of FIG. 1 illustrates the processing component(s) 102, the language model(s) 110, the language model(s) 118, and the language model(s) 126 as all being separate, in other examples, the processing component(s) 102, the language model(s) 110, the language model(s) 118, and the language model(s) 126 may be combined into one or more models. For example, the language model(s) 110 and the language model(s) 118 may be combined into a single language model that performs one or more of the processes described herein with respect to the language model(s) 110 and the language model(s) 118.

Additionally, as described herein, a language model may include, but is not limited to, a statistic language model, a neural language model, a probabilistic language model, a large language model, a vision language model, and/or any other type of language model. Furthermore, while the examples herein describe using language models to perform the process 100 of FIG. 1, in other examples, any other type of model may be used to perform at least a portion of the process 100 of FIG. 1. For example, the language model(s) 110, the language model(s) 118, and/or the language model(s) 126 may include any other type of model that is configured to perform at least a portion of the processes described herein.

Furthermore, the process 100 may be perform using a single computing device, such as a computing device 1000 and/or a data center 1100 that includes the various components and/or language models, and/or using multiple computing devices, such as multiple computing devices 1000 and/or data centers 1100 that each include at least a portion of the components and/or language models and communicate with one another over one or more networks.

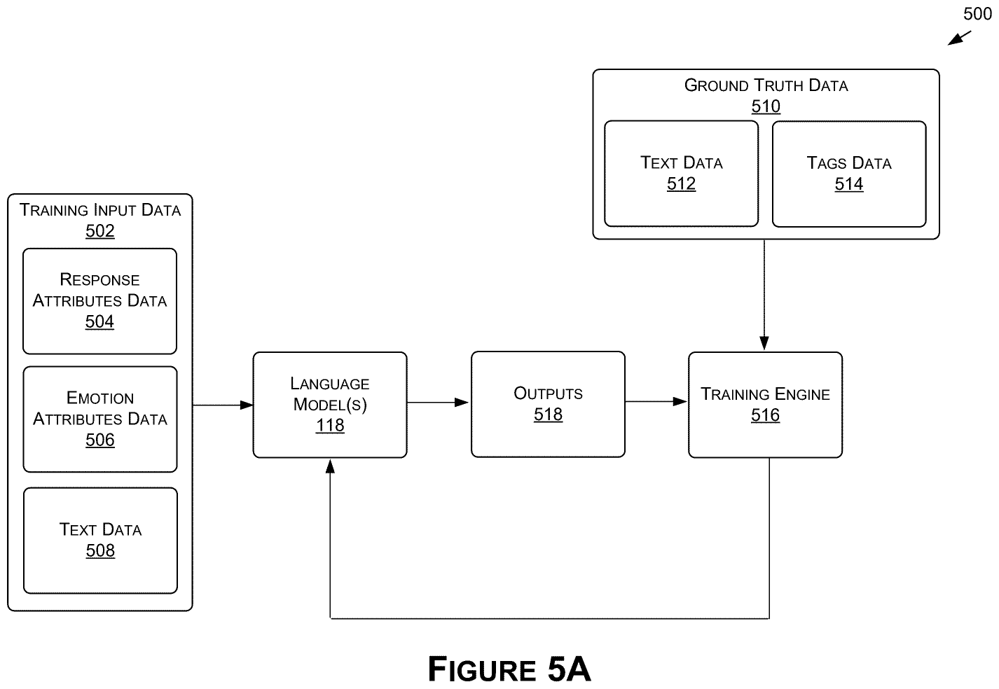

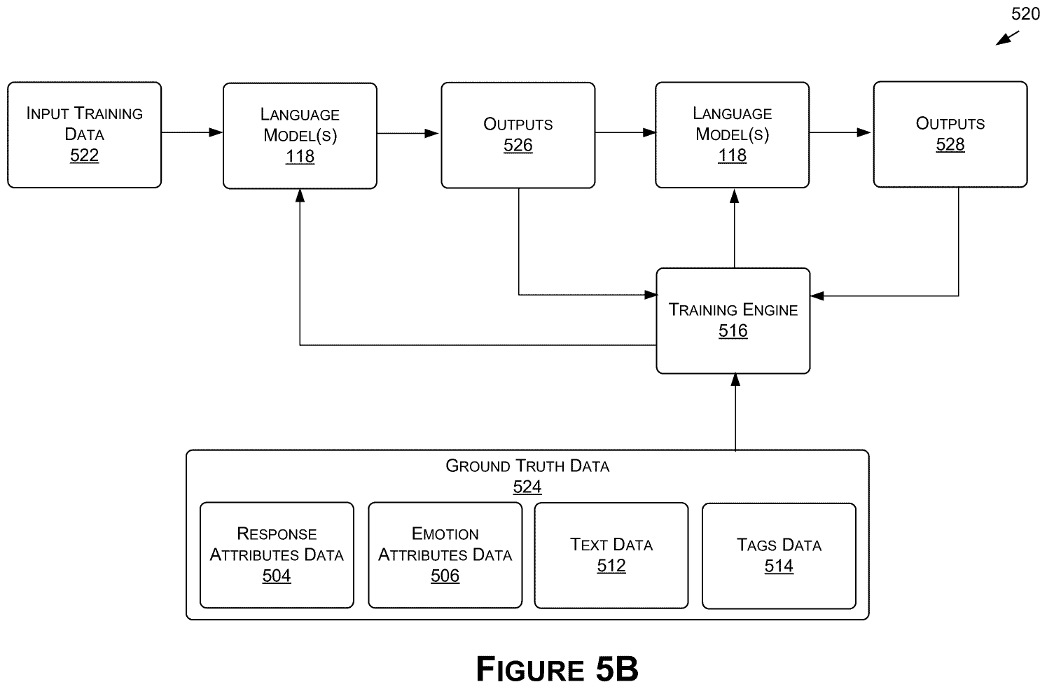

As described herein, in some examples, the language model(s) 110 and/or the language model(s) 118 may be trained using various training stages. For instance, FIG. 5A illustrates a data flow diagram illustrating a process 600 for training one or more language models to generate speech that expresses emotion during a first training stage, in accordance with some embodiments of the present disclosure. As shown, the language model(s) 118 may be trained using training input data 502. In some examples, the training input data 502 may include response attributes data 504, which may be similar to and/or include the response attributes data 114, and emotion attributes data 506, which may be similar to and/or include the emotion attributes data 116. Additionally, the training input data 502 may include text data 508 representing one or more instances of input text, such as one or more prompts. The training input data 502 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof.

The language model(s) 118 may be trained using the training input data 502 as well as corresponding ground truth data 510. The ground truth data 510 may include annotations, labels, masks, and/or the like. For instance, and as shown, the ground truth data 510 may include at least text data 512, which may be similar to and/or include the text data 122, and tags data 514, which may be similar to and/or include the tags data 124. For example, the text data 512 may represent one or more instances of output text (e.g., speech synthesis markup language, etc.) associated with the instance(s) of input text, such as one or more responses to the one or more prompts. Additionally, in some examples, the tags data 124 may represent one or more tags associated with at least one of emotion (e.g., one or more emotional states) or one or more characteristics associated with speech. The ground truth data 510 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the training input data 502, there may be corresponding ground truth data 510.

As further illustrated in FIG. 5A, a training engine 516 may use one or more loss functions that measure loss (e.g., error) in outputs 518 as compared to the ground truth data 510. In some examples, the outputs 518 may be similar to and/or include the output data 120. Any type of loss function may be used, such as cross entropy loss, mean squared error, mean absolute error, mean bias error, and/or other loss function types. In some examples, different outputs 518 may have different loss functions. For example, the instance(s) of output text may have a first loss function and the voice tag(s) may have a second loss function. In such examples, the loss functions may be combined to form a total loss, and the total loss may be used to train (e.g., update the parameters of) the language model(s) 118. In any example, backward pass computations may be performed to recursively compute gradients of the loss function(s) with respect to training parameters. In some examples, weights and biases of the language model(s) 118 may be used to compute these gradients.

Next, FIG. 5B illustrates a data flow diagram illustrating a process 520 for training one or more language models to generate speech that expresses emotion during a second training stage, in accordance with some embodiments of the present disclosure. As shown, the language model(s) 110 and/or the language model(s) 118 may be trained using training input data 522. In some examples, the training input data 522 may be similar to and/or include at least a portion of the data that is input into the language model(s) 110 during the process 100 of FIG. 1. For instance, the training input data 522 may be similar to and/or include at least a portion of the user data 104, the input data 106, the user attributes data 108, and/or the dialogue data 112. The training input data 522 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof.

The language model(s) 110 and/or the language model(s) 118 may be trained using the training input data 522 as well as corresponding ground truth data 524. The ground truth data 510 may include annotations, labels, masks, and/or the like. For instance, and as shown, the ground truth data 524 may include at least response attributes data 504, the emotion attributes data 506, the text data 512, and/or the tags data 514. As described herein, the ground truth data 524 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof. In some examples, for each instance of the input training data 522, there may be corresponding ground truth data 524.

As described herein, in some examples, the second stage of training may be performed using different techniques. For instance, and for a first technique that just includes training the language model(s) 110, the training engine 516 may use one or more loss functions that measure loss (e.g., error) in outputs 526 as compared to the ground truth data 524. In such examples, the outputs 526 may be similar to and/or include the response attributes data 114 and/or the emotion attributes data 116. Any type of loss function may be used, such as cross entropy loss, mean squared error, mean absolute error, mean bias error, and/or other loss function types. In some examples, different outputs 526 may have different loss functions. For example, the response generic attributes may have a first loss function, the response emotion attributes may have a second loss function, and the user emotion attributes may have a third loss function. In such examples, the loss functions may be combined to form a total loss, and the total loss may be used to train (e.g., update the parameters of) the language model(s) 110. In any example, backward pass computations may be performed to recursively compute gradients of the loss function(s) with respect to training parameters. In some examples, weights and biases of the language model(s) 110 may be used to compute these gradients.

Additionally, or alternatively, in some examples, the second stage of training may include a second technique that includes training the language model(s) 110 and/or the language model(s) 118. For instance, the training engine 516 may use one or more loss functions that measure loss (e.g., error) in outputs 528 as compared to the ground truth data 524, where the outputs 528 may be similar to the output data 120. Any type of loss function may be used, such as cross entropy loss, mean squared error, mean absolute error, mean bias error, and/or other loss function types. In some examples, different outputs 528 may have different loss functions. For example, the instance(s) of output text may have a first loss function and the voice tag(s) may have a second loss function. In such examples, the loss functions may be combined to form a total loss, and the total loss may be used to train (e.g., update the parameters of) the language model(s) 110 and/or the language model(s) 118. In any example, backward pass computations may be performed to recursively compute gradients of the loss function(s) with respect to training parameters. In some examples, weights and biases of the language model(s) 110 and/or the language model(s) 118 may be used to compute these gradients.

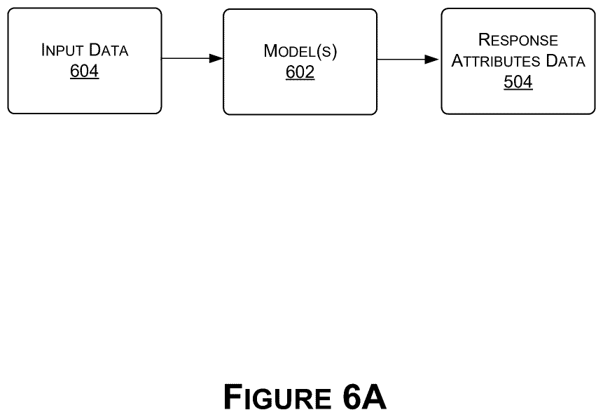

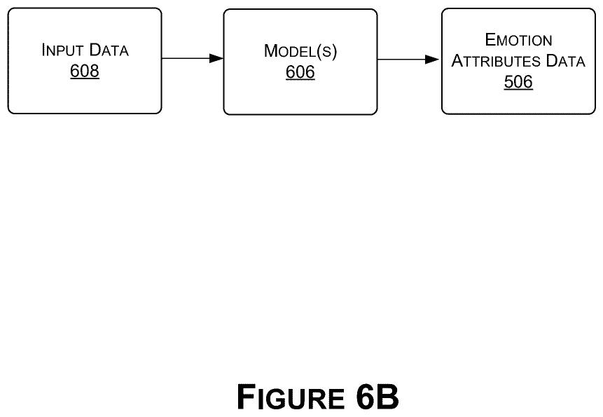

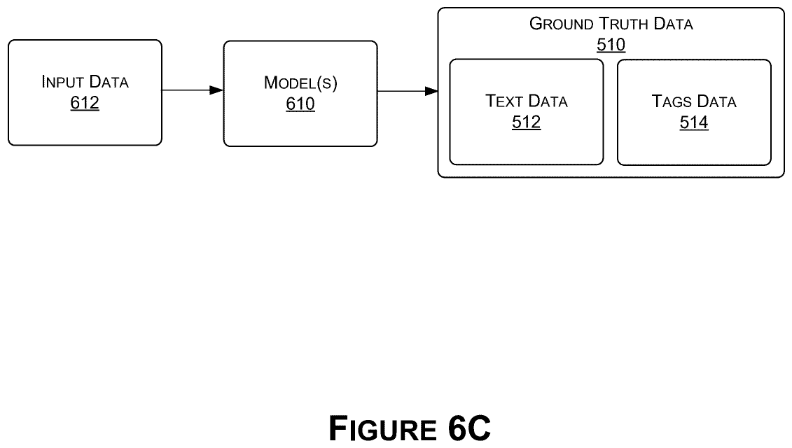

As described herein, in some examples, at least a portion of the training input data and/or the ground truth data that are used to train the language model(s) 110 and/or the language model(s) 118 may be produced using one or more models. For instance, FIG. 6A illustrates an example of generating response attributes for training one or more language models, in accordance with some embodiments of the present disclosure. As shown, one or more models 602 may receive input data 604. As described herein, in some examples, the input data 604 may represent one or more emotional responses, similar to the text data 122, a dialogue history, similar to the dialogue data 112, and/or any other data. Additionally, the output from the model(s) 602 may include the response attributes data 504 that is used to train the language model(s) 110 and/or the language model(s) 118. In some examples, the model(s) 602 may include a regression layer that uses a language model token output embedding to predict the response attributes data 504. However, in other examples, the model(s) 602 may include any other type of model.

Additionally, FIG. 6B illustrates an example of generating emotion attributes for training one or more language models, in accordance with some embodiments of the present disclosure. As shown, one or more models 606 may receive input data 608. As described herein, in some examples, the input data 608 may represent one or more emotional responses, similar to the text data 122, a dialogue history, similar to the dialogue data 112, and/or any other data. Additionally, the output from the model(s) 606 may include the emotion attributes data 506 that is used to train the language model(s) 110 and/or the language model(s) 118. In some examples, the model(s) 606 may include a regression layer that uses a language model token output embedding to predict the emotion attributes data 506. However, in other examples, the model(s) 606 may include any other type of model.

Furthermore, FIG. 6C illustrates an example of generating ground truth data for training one or more language models, in accordance with some embodiments of the present disclosure. As shown, one or more models 610 may receive input data 612. As described herein, in some examples, the input data 612 may represent one or more emotional responses, similar to the text data 122, a dialogue history, similar to the dialogue data 112, and/or any other data. Additionally, the output from the model(s) 610 may include the ground truth data 510 that is used to train the language model(s) 110 and/or the language model(s) 118. In some examples, the model(s) 610 may include an autoregressive decoder-only transformer model which generates SSML-tagged responses sequentially. However, in other examples, the model(s) 610 may include any other type of model.

In some examples, at least a portion of the input data 604 from the example of FIG. 6A, at least a portion of the input data 608 from the example of FIG. 6B, and/or at least a portion of the input data 612 from the example of FIG. 6C may include the same input data. Additionally, in some examples, at least a portion of the input data 604 from the example of FIG. 6A, at least a portion of the input data 608 from the example of FIG. 6B, and/or at least a portion of the input data 612 from the example of FIG. 6C may include at least a portion of the training input data 502 from the example of FIG. 5A and/or at least a portion of the training input data 522 from the example of FIG. 5B. This way, the model(s) 602, the model(s) 606, and/or the model(s) 610 may process the same input data in order to generate instances of training data for training the language model(s) 110 and/or the language model(s) 118.

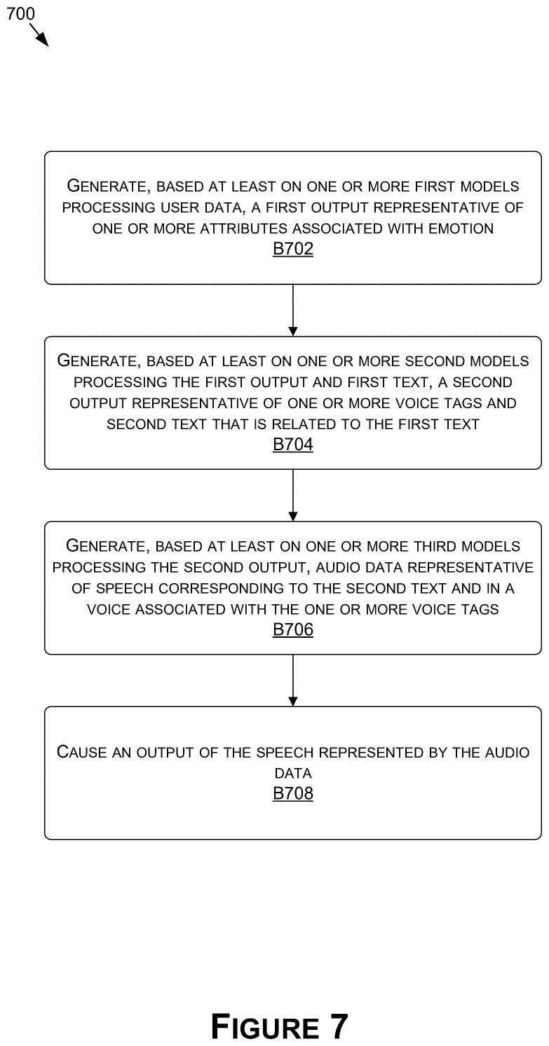

Now referring to FIGS. 7-9, each block of methods 700, 800, and 900, described herein, comprises a computing process that may be performed using any combination of hardware, firmware, and/or software. For instance, various functions may be carried out by a processor executing instructions stored in memory. The methods 700, 800, and 900 may also be embodied as computer-usable instructions stored on computer storage media. The methods 700, 800, and 900 may be provided by a standalone application, a service or hosted service (standalone or in combination with another hosted service), or a plug-in to another product, to name a few. In addition, the methods 700, 800, and 900 are described, by way of example, with respect to FIG. 1. However, these methods 700, 800, and 900 may additionally or alternatively be executed by any one system, or any combination of systems, including, but not limited to, those described herein.

FIG. 7 illustrates a flow diagram showing a method 700 for using models to generate speech that expresses emotion, in accordance with some embodiments of the present disclosure. The method 700, at block B702, may include generating, based at last on one or more first models processing user data, a first output representative of one or more attributes associated with emotion. For instance, the language model(s) 110 may receive, as input, the user data 104 and/or the user attributes data 108. In some examples, the language model(s) 110 may further receive, as input, the input data 106 and/or the dialogue data 112. The language model(s) 110 may then process the data in order to generate the first output that includes the emotion attributes data 116. As described herein, in some examples, the emotion attributes data 116 may represent the attribute(s) associated with emotion, such as one or more response emotion attributes and/or one or more user emotion attributes. Additionally, in some examples, the first output may include the response attributes data 114.

The method 700, at block B704, may include generating, based at least on one or more second models processing the first output and first text, a second output representative of one or more voice tags and second text that is related to the first text. For instance, the language model(s) 118 may receive, as input, the emotion attributes data 116 and the input data 106 representing the first text. In some examples, the language model(s) 118 may further receive, as input, the response attributes data 114 and/or the input data 106 representing information associated with the character and/or the application. The language model(s) 118 may then process the data in order to generate the output data 120. As described herein, the output data 120 may include at least the text data 122 representing the second text and the tags data 124 representing the voice tag(s) associated with the second text. In some examples, the voice tag(s) may include one or more emotion tags and/or one or more speech characteristic tags.

The method 700, at block B706, may include generating, based at least on one or more third models processing the second output, audio data representative of speech corresponding to the second text and in a voice associated with the one or more voice tags. For instance, the language model(s) 126 may receive, as input, the output data 120 from the language model(s) 118. The language model(s) 126 may then process the output data 120 in order to generate the audio data 128 representing the speech corresponding to the second text that is in the voice associated with the voice tag(s). For example, the voice may be represented using emotion that is associated with the emotion tag(s) and/or may include one or more characteristics associated with the speech characteristic tag(s).

The method 700, at block B708, may include causing an output of the speech represented by the audio data. For instance, the speech represented by the audio data 128 may be output, such as by one or more characters. In some examples, by performing the processes described herein, the character(s) may thus output the speech such that the character(s) is displaying emotion.

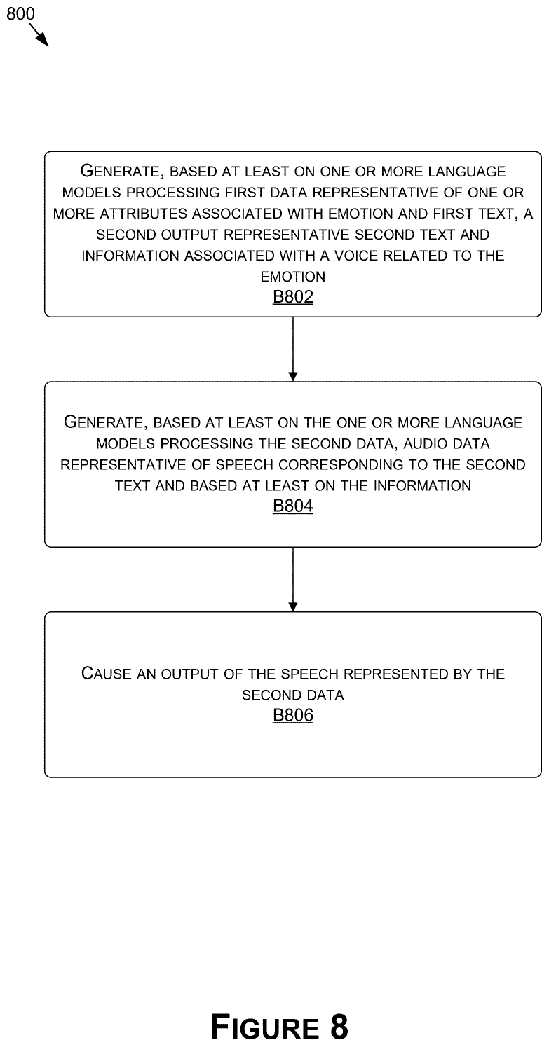

FIG. 8 illustrates a flow diagram showing a method 800 for using one or more models that control emotions to generate speech, in accordance with some embodiments of the present disclosure. The method 800, at block B802, may include generating, based at least on one or more language models processing first data representative of one or more attributes associated with emotion and first text, a second output representative of second text and information associated with a voice related to the emotion. For instance, the language model(s) 118 may receive, as input, the emotion attributes data 116 representing the attribute(s) associated with the emotion and the input data 106 representing the first text. Additionally, in some examples, the language model(s) 118 may receive, as input, the response attributes data 114 and/or the input data representing information associated with the character and/or the application. The language model(s) 118 may then process the data in order to generate the output data 120. As described herein, the output data 120 may include at least the text data 122 representing the second text and the tags data 124 representing the information, such as the voice tag(s) associated with the second text.

The method 800, at block B804, may include generating, based at least on the one or more language models processing the second data, audio data representative of speech corresponding to the second text and based at least on the information. For instance, the language model(s) 126 may receive, as input, the output data 120 from the language model(s) 118. The language model(s) 126 may then process the output data 120 in order to generate the audio data 128 representing the speech corresponding to the second text that is in the voice associated with the information. For example, the voice may be represented using emotion that is associated with the emotion tag(s) and/or may include one or more characteristics associated with the speech characteristic tag(s).

The method 800, at block B806, may include causing an output of the speech represented by the audio data. For instance, the speech represented by the audio data 128 may be output, such as by one or more characters. In some examples, by performing the processes described herein, the character(s) may thus output the speech such that the character(s) is displaying emotion.

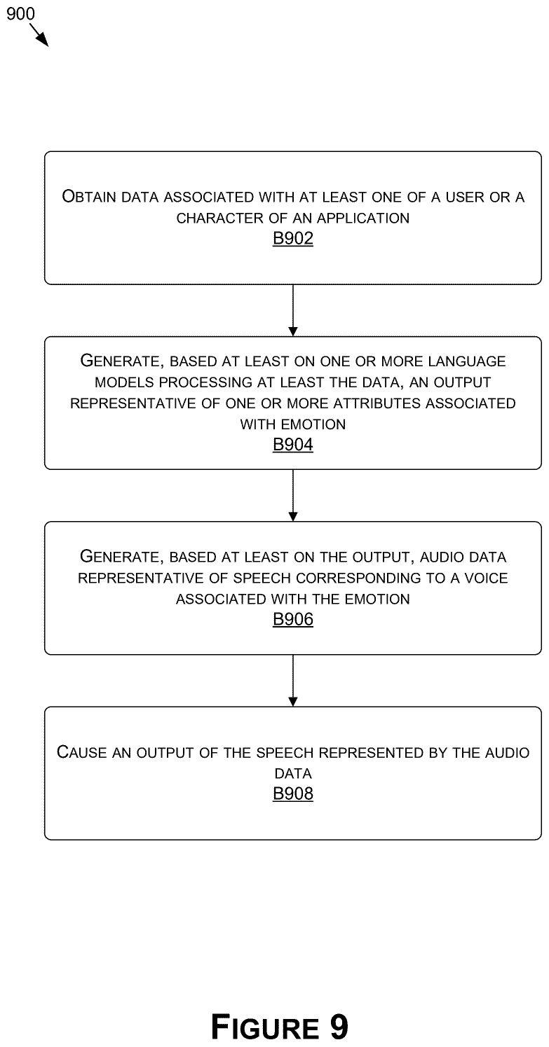

FIG. 9 illustrates a flow diagram showing a method 900 for using one or more models that manage emotion dialogue to generate speech, in accordance with some embodiments of the present disclosure. The method 900, at block B902, may include obtaining data associated with at least one of a user or a character of an application. For instance, the user data 104 associated with the user, the user attributes data 108 associated with the user, and/or the input data 106 representing the character information may be obtained. As described herein, the user may be having a conversation with the character. As such, and in some examples, additional data may be obtained, such as the dialogue data 112 representing the conversation between the user and the character.

The method 900, at block B904, may include generating, based at least on one or more language models processing at least the data, an output representative of one or more attributes associated with emotion. For instance, the language model(s) 110 may process the user data 104, the user attributes data 108, and/or the input data. Based at least on the processing, the language model(s) 110 may generate and/or output the emotion attributes data 116 representing the attribute(s) associated with the emotion. As described herein, the attribute(s) may include one or more response emotion attributes and/or one or more user emotion attributes. Additionally, in some examples, based at least on the processing, the language model(s) 110 may generate and/or output the response attributes data 114 representing one or more response generic attributes.

The method 900, at block B906, may include generating, based at least on the output, audio data representative of speech corresponding to a voice associated with the emotion. For instance, the language model(s) 118 may process the response attributes data 114 and/or the emotion attributes data 116 in order to generate the output data 120. The language model(s) 126 may then process the output data 120 in order to generate the audio data 126 representing the speech. As described herein, the speech may be in a voice that is associated with the emotion.

The method 900, at block B908, may include causing an output of the speech represented by the audio data. For instance, the speech represented by the audio data 128 may be output, such as by one or more characters. In some examples, by performing the processes described herein, the character(s) may thus output the speech such that the character(s) is displaying emotion.

### Example Computing Device

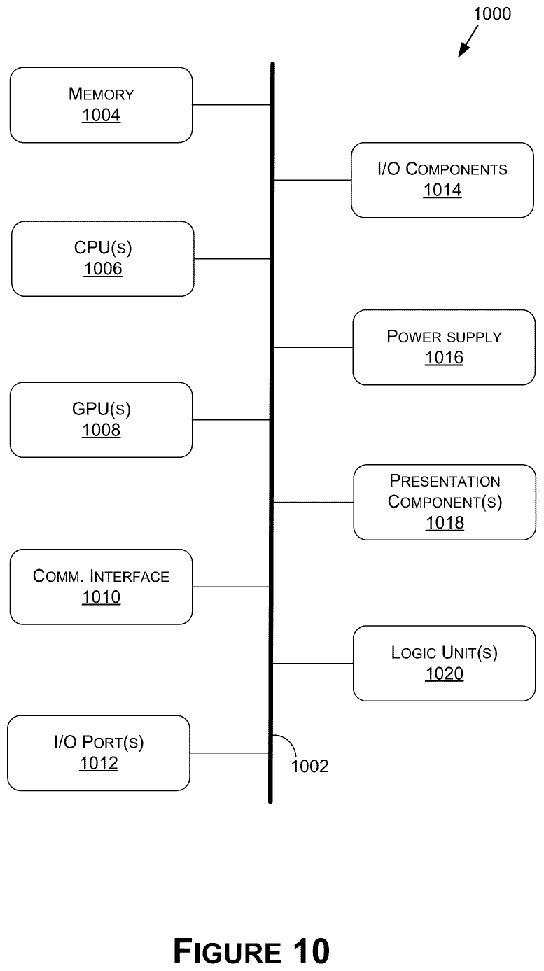

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that enable the computing device 1000 to communicate with other computing devices via an electronic communication network, included wired and/or wireless communications. The communication interface 1010 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O ports 1012 may enable the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that enable detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to enable the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

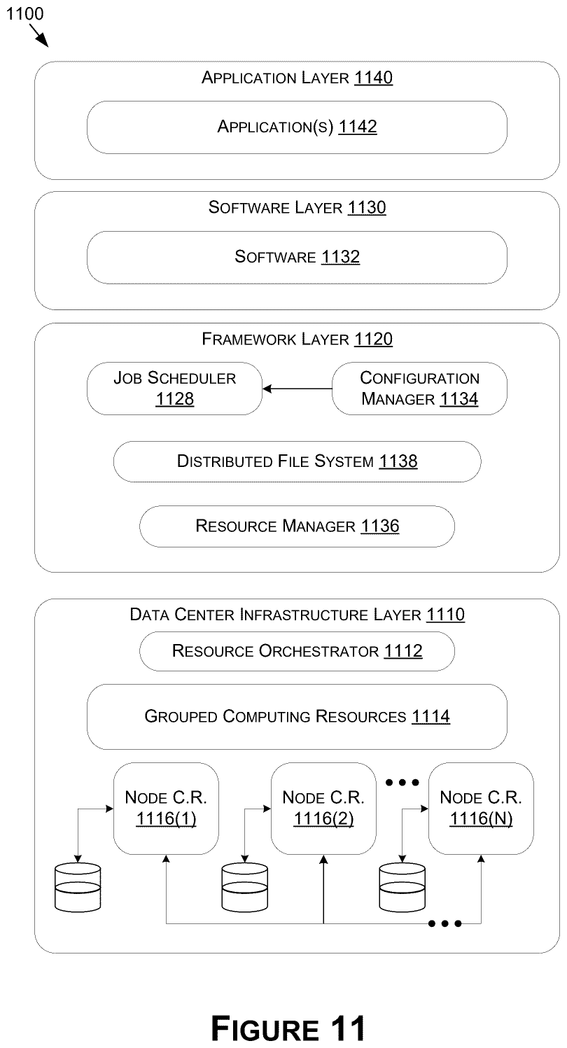

FIG. 11 illustrates an example data center 1100 that may be used in at least one embodiments of the present disclosure. The data center 1100 may include a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-11161(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™M (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers such as software layer 1130 and framework layer 1120 including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment-and one or more client-server network environments-in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web- based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: generating, based at least on one or more first models processing user data, a first output representative of one or more attributes associated with one or more emotional states; generating, based at least on one or more second models processing the first output and a prompt, a second output representative of a response to the prompt and one or more tags corresponding to a voice that is related to the one or more attributes; generating, based at least on processing the second output, audio data representative of speech corresponding to the response and expressed using the voice; and causing an output of the speech represented by the audio data.

B: The method of paragraph A, further comprising: generating, based at least on the one or more first models processing character data, a third output representative of one or more second attributes associated with a character, wherein the generating of the second output is further based at least on the one or more second models processing the third output.

C: The method of either paragraph A or paragraph B, further comprising: obtaining character data representative of one or more second attributes associated with a character that is to output the speech, wherein the generating of the second output is further based at least on the one or more second models processing the character data.

D: The method of any one of paragraphs A-C, further comprising: obtaining data representative of at least one of one or more previous prompts or one or more previous responses associated with the one or more previous prompts, wherein the generating the first output is further based at least on the one or more first models processing the data representative of the at least one of the one or more previous prompts or the one or more previous responses.

E: The method of any one of paragraphs A-D, wherein the user data comprises at least one of: text data representative of text describing one or more second emotional states associated with a user; audio data representative of user speech corresponding to the user; video data representative of one or more videos corresponding to the user; or image data representative of one or more images corresponding to the user.

F: A system comprising: one or more processors to: generate, based at least on one or more language models processing first data representative of one or more emotional states and first text, second data representative of second text and information associated with a voice related to the one or more emotional states; generate, based at least on the second data, audio data representative of speech corresponding to the second text and expressed using the voice; and cause an output of the speech represented by the audio data.

G: The system of paragraph F, wherein: the one or more emotional states includes at least a first emotional state associated with outputting a response corresponding to the second text and a second emotional state associated with outputting the response corresponding to the second text; and the first data is further representative of a first value associated with the first emotional state and a second value associated with the second emotional state.

H: The system of either paragraph F or paragraph G, wherein: the one or more emotional states includes at least a first emotional state associated with a user and a second emotional state associated with the user; and the first data is further representative of a first value associated with the first emotional state and a second value associated with the second emotional state.

I: The system of any one of paragraphs F-H, wherein the second data is further generated based at least on the one or more language models processing third data representative of one or more attributes associated with a character that is to output the speech.

J: The system of paragraph I, wherein the second data is representative of at least one of: one or more labels describing the one or more attributes associated with the character; or one or more intensity values associated with the one or more labels.

K: The system of any one of paragraphs F-J, wherein the information associated with the voice related to the one or more emotional states comprises at least one of: one or more second emotional states associated with the voice; one or more first values associated with the one or more second emotional states; one or more voice characteristics associated with the voice; or one or more second values associated with the one or more voice characteristics.

L: The system of any one of paragraphs F-K, wherein the one or more processors are further to: obtain third data associated with a user; and generate, based at least on the one or more language models processing the third data, the first data representative of the one or more emotional states.

M: The system of paragraph L, wherein the third data comprises at least one of: text data representative of text describing one or more second emotional states associated with the user; audio data representative of user speech corresponding to the user; or image data representative of one or more images corresponding to the user.

N: The system of any one of paragraphs F-M, wherein the one or more processors are further to: generate, based at least on the one or more language models processing third data representative of one or more second emotional states and third text, fourth data representative of fourth text and second information associated with a second voice related to the one or more second emotional states; generate, based at least on the fourth data, second audio data representative of second speech corresponding to the fourth text and expressed using the second voice; and cause a second output of the second speech represented by the second audio data.

O: The system of paragraph N, wherein the one or more processors are further to generate, based at least on the one or more language models processing fifth data associated with a user, the first text, and the second text, the third data representative of the one or more second emotional states.

P: The system of any one of paragraphs F-O, wherein: one or more first language models of the one or more language models generate the first data representative of the one or more emotional states; one or more second language models of the one or more language models generate the second data representative of the second text and the information associated with the voice related to the one or more emotional states; and one or more third language models of the one or more language models generate the audio data representative of the speech.

Q: The system of any one of paragraphs F-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

R: One or more processors comprising: processing circuitry to generate audio data representative of speech in a voice related to one or more emotional states, wherein the audio data is generated based at least on one or more language models processing first data associated with a user that provides a prompt associated with a response and second data representative of one or more attributes associated with a character that is to output the speech.

S: The one or more processors of paragraph R, wherein the processing circuitry is further to: generate, based at least on the one or more language models processing at least one of the first data or the second data, third data representative of the one or more emotional states or one or more second emotional states associated with the user, wherein the audio data is generated based at least on the one or more language models further processing the second data and the third data.

T: The one or more processors of ether paragraph R or paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
generating, based at least on one or more first models processing user data, a first output representative of one or more attributes associated with one or more emotional states;
generating, based at least on one or more second models processing the first output and a prompt, a second output representative of a response to the prompt and one or more tags corresponding to a voice that is related to the one or more attributes;
generating, based at least on processing the second output, audio data representative of speech corresponding to the response and expressed using the voice; and
causing an output of the speech represented by the audio data.

2. The method of claim 1, further comprising:
generating, based at least on the one or more first models processing character data, a third output representative of one or more second attributes associated with a character,
wherein the generating of the second output is further based at least on the one or more second models processing the third output.

3. The method of claim 1, further comprising:
obtaining character data representative of one or more second attributes associated with a character that is to output the speech,
wherein the generating of the second output is further based at least on the one or more second models processing the character data.

4. The method of claim 1, further comprising:
obtaining data representative of at least one of one or more previous prompts or one or more previous responses associated with the one or more previous prompts,
wherein the generating the first output is further based at least on the one or more first models processing the data representative of the at least one of the one or more previous prompts or the one or more previous responses.

5. The method of claim 1, wherein the user data comprises at least one of:
text data representative of text describing one or more second emotional states associated with a user;
audio data representative of user speech corresponding to the user;
video data representative of one or more videos corresponding to the user; or
image data representative of one or more images corresponding to the user.

6. A system comprising:
one or more processors to:
generate, based at least on one or more language models processing first data representative of one or more emotional states and first text, second data representative of second text and information associated with a voice related to the one or more emotional states;
generate, based at least on the second data, audio data representative of speech corresponding to the second text and expressed using the voice; and
cause an output of the speech represented by the audio data.

7. The system of claim 6, wherein:
the one or more emotional states includes at least a first emotional state associated with outputting a response corresponding to the second text and a second emotional state associated with outputting the response corresponding to the second text; and
the first data is further representative of a first value associated with the first emotional state and a second value associated with the second emotional state.

8. The system of claim 6, wherein:
the one or more emotional states includes at least a first emotional state associated with a user and a second emotional state associated with the user; and
the first data is further representative of a first value associated with the first emotional state and a second value associated with the second emotional state.

9. The system of claim 6, wherein the second data is further generated based at least on the one or more language models processing third data representative of one or more attributes associated with a character that is to output the speech.

10. The system of claim 9, wherein the second data is representative of at least one of:
one or more labels describing the one or more attributes associated with the character; or
one or more intensity values associated with the one or more labels.

11. The system of claim 6, wherein the information associated with the voice related to the one or more emotional states comprises at least one of:
one or more second emotional states associated with the voice;
one or more first values associated with the one or more second emotional states;
one or more voice characteristics associated with the voice; or
one or more second values associated with the one or more voice characteristics.

12. The system of claim 6, wherein the one or more processors are further to:
obtain third data associated with a user; and
generate, based at least on the one or more language models processing the third data, the first data representative of the one or more emotional states.

13. The system of claim 12, wherein the third data comprises at least one of:
text data representative of text describing one or more second emotional states associated with the user;
audio data representative of user speech corresponding to the user; or
image data representative of one or more images corresponding to the user.

14. The system of claim 6, wherein the one or more processors are further to:
generate, based at least on the one or more language models processing third data representative of one or more second emotional states and third text, fourth data representative of fourth text and second information associated with a second voice related to the one or more second emotional states;
generate, based at least on the fourth data, second audio data representative of second speech corresponding to the fourth text and expressed using the second voice; and
cause a second output of the second speech represented by the second audio data.

15. The system of claim 14, wherein the one or more processors are further to generate, based at least on the one or more language models processing fifth data associated with a user, the first text, and the second text, the third data representative of the one or more second emotional states.

16. The system of claim 6, wherein:
one or more first language models of the one or more language models generate the first data representative of the one or more emotional states;
one or more second language models of the one or more language models generate the second data representative of the second text and the information associated with the voice related to the one or more emotional states; and
one or more third language models of the one or more language models generate the audio data representative of the speech.

17. The system of claim 6, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

18. One or more processors comprising:
processing circuitry to generate audio data representative of speech in a voice related to one or more emotional states, wherein the audio data is generated based at least on one or more language models processing first data associated with a user that provides a prompt associated with a response and second data representative of one or more attributes associated with a character that is to output the speech.

19. The one or more processors of claim 18, wherein the processing circuitry is further to:
generate, based at least on the one or more language models processing at least one of the first data or the second data, third data representative of the one or more emotional states or one or more second emotional states associated with the user,
wherein the audio data is generated based at least on the one or more language models further processing the second data and the third data.

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
